(19) United States
(12) Patent Application Publication
(10) Pub. No.: US 2025/0265401 A1
(43) Pub. Date: Aug. 21, 2025

(54) Format Conversion and Application Method for SOC DFT Burn-in Vectors

(71) Applicant: Jiangsu Huachuang Microsystem Company Limited, Nanjing (CN)

(72) Inventors: Yongdong FAN, Nanjing (CN); Shiping LI, Nanjing (CN)

(73) Assignee: Jiangsu Huachuang Microsystem Company Limited, Nanjing (CN)

(21) Appl. No.: 19/004,518

(22) Filed: Dec. 30, 2024

(30) Foreign Application Priority Data
Feb. 20, 2024 (CN) 202410187110.7

(51) Int. Cl. G06F 30/333; G06F 115/02

(52) U.S. Cl. CPC G06F 30/333; G06F 2115/02

(57) ABSTRACT

A format conversion and application method for SOC DFT burn-in vectors includes: S1, generating multiple original vectors in an STIL format, and setting a timeplate corresponding to each original vector; performing primary simulation, and preliminarily modulating each original vector according to a simulation result; S2, converting, by a format conversion tool, each original vector into a vector in a flat format; S3, according to each format feature, extracting corresponding vector data, and performing character substitution; S4, aligning data bits within a fixed length of the vector data subjected to character substitution, adding a corresponding data flag field at the end of each piece of vector data, and splicing all the vector data to form a complete stimulus data source; and S5, loading, by a test tool, the stimulus data source to carry out a burn-in test. The method can carry out a burn-in test quickly by vector format conversion.

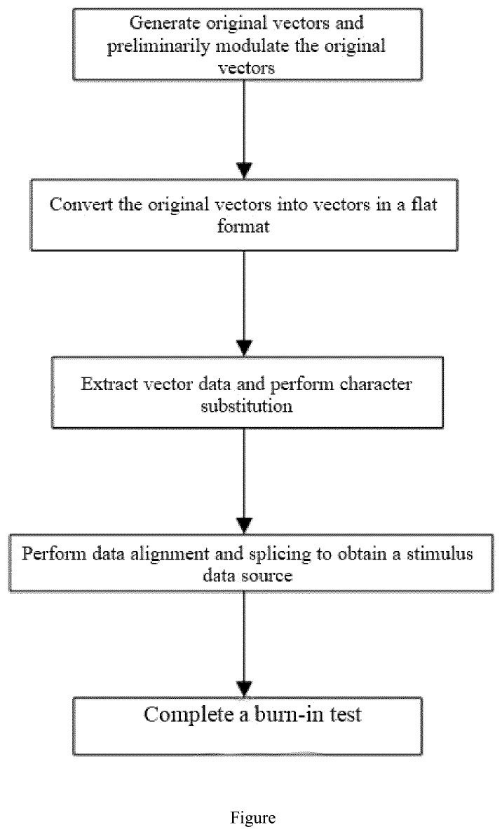

### CROSS REFERENCE TO THE RELATED APPLICATIONS

This application is based upon and claims priority to Chinese Patent Application No. 202410187110.7, filed on Feb. 20, 2024, the entire contents of which are incorporated herein by reference.

### TECHNICAL FIELD

The invention relates to the field of processor design, in particular to a format conversion and application method for SOC DFT burn-in vectors.

### BACKGROUND

Design for test/testability (DFT) is generally integrated in systems on chip (SOCs) and specially designed for production testing of chips to check defects in the chip production and fabrication process and detect the reliability and stability of the chips, and has broad application scenarios.

Burn-in testing, as a stage in the chip screening process, is carried out to uncover in advance possible hidden defects in the chip fabrication process and eliminate invalid chips to improve the reliability and stability of chips that are produced and supplied in batches.

However, existing burn-in screening approaches for SOCs include functional programs, DFT vectors used as stimuli, and the combination of functional programs and DFT vectors, and these three approaches can drive the SOCs to run for burn-in. Wherein, the first approach has the problems of low coverage of a logic circuit of the SOCs and low burn-in efficiency; and the DFT vectors adopted in the second and third approaches cannot be directly used by an embedded system, and a DFT test device such as a dedicated burn-in oven is needed, thus greatly increasing the cost.

### SUMMARY

The technical issue to be settled by the invention is how to design, after DFT of a SOC, burn-in vectors that can be directly used by an embedded system to reduce the burn-in cost, improve the burn-in rate and efficiency and increase the coverage of a logic circuit.

To settle the above technical issue, the invention provides a format conversion and application method for SOC DFT burn-in vectors; which is implemented by the following technical solution:

A format conversion and application method for SOC DFT burn-in vectors, wherein tools used in DFT include a vector generation tool, a format conversion tool and a test tool, includes the following steps:
S1, after DFT of an SOC is completed, generating multiple original vectors in an STIL format by the vector generation tool, and setting a timeplate corresponding to each original vector; performing primary simulation on each original vector, and preliminarily modulating each original vector according to a primary simulation result;
S2, converting, by the format conversion tool, each original vector preliminarily modulated in S1 into a vector in a flat format;
S3, according to format features of each vector in the flat format in S2, extracting a corresponding piece of vector data from each vector in the flat format, and performing character substitution on each piece of vector data;
S4, aligning data bits within a fixed length of the vector data subjected to character substitution in S3, adding a corresponding data flag field at the end of each piece of vector data, and splicing all the vector data subjected to character substitution according to each data flag field to form a complete stimulus data source; and
S5, loading, by the test tool, the stimulus data source in S4 to complete a burn-in test

According to the invention, a dedicated burn-in oven is not needed, and SOC DFT vectors are extracted and converted to obtain a vector file that can be used in a general purpose embedded system as signal stimuli to drive an SOC to run for burn-in, such that the test cost is greatly reduced; simulation is performed instantly after original vectors are generated, and the original vectors can be preliminarily modulated according to a simulation result to improve the validity of the original vectors, such that the coverage of a gate circuit of the SOC is increased; in addition, format conversion and character substation are performed on the original vectors to obtain vectors that can directly run on the embedded system, such that the running efficiency and testing speed are improved.

Preferably, each of the multiple original vectors generated in S1 includes a corresponding signal set, and all the signal sets adopt a unified waveform template. A unified waveform is set, such that differences and fluctuations between different vector data can be eliminated, and unnecessary calculation and conversion are reduced, thus increasing the processing speed and facilitating subsequent data combination.

Preferably, in S3, a method for extracting corresponding vector data from each vector in the flat format includes: recognizing vector syntactic keywords in each vector in the flat format, and extracting the corresponding vector data from each vector in the flat format according to the vector syntactic keywords. Keywords are core data that can represent vectors in a flat format, the extraction of information corresponding to the keywords is further refinement of vectors, and valid data can be obtained, such that the processing efficiency is improved under the condition of guaranteeing accuracy.

Preferably, in S1, multiple pin signals are used in DFT of the SOC; and when character substitution is performed in S3, each pin signal is converted into a corresponding specific cycle waveform, and character substitution is performed on special characters in each piece of vector data according to each specific cycle waveform. All the vectors in the invention adopt a unified waveform template, such that the vectors can be directly used later by an embedded system according to waveform descriptions, and conflicts between different vector data can be avoided.

Preferably, in S3, the number of characters of each piece of vector data before character substitution is equal to the number of bytes of the piece of vector data after character substitution, and the characters before character substitution are in one-to-one correspondence with the bytes after character substitution. The number of bits of data remains unchanged after character substitution, such that the consistency and integrity of data can be maintained, the data can be processed by the embedded system, the execution efficiency is improved, and format problems are avoided.

Preferably, in S4, each data flag field at least includes an end identifier, a category and effective cycles of the corresponding vector data. The end identifier, category and effective cycles are core features of each piece of vector data, and the data flag field includes these core features, such that different vector data can be distinguished and used by means of these core features, and errors will not be caused when multiple pieces of vector data are spliced into a stimulus data source.

Preferably, in S5, before the burn-in test is carried out, data of the stimulus data source are checked by CRC. Data of the stimulus data source are checked by CRC, and erroneous data can be found in time, such that the accuracy of data is guaranteed, thus guaranteeing the accuracy of a test.

Preferably, in S2, each vector in the flat format at least includes a corresponding signal set definition, a corresponding timeplate and a corresponding pattern set. The accuracy of vectors obtained after format conversion is ensured by a signal set definition, timeplate and a pattern set, and a subsequent test is carried out according to the information.

Preferably, in S5, the test tool is an embedded test system board. An embedded test system board has high flexibility and real-time performance, thus facilitating testing and observation.

Compared with the prior art, the invention has the following beneficial effects:

According to the invention, original vectors are generated by various software tools for DFT and can be directly used by an embedded system, and special test equipment is not needed anymore, such that the cost is effectively reduced; moreover, the original vectors are simulated and preliminarily modulated instantly after being generated, such that the validity of the original vectors is improved, thus increasing the coverage of a gate circuit of a SOC; in addition, by means of format conversion and character substation, the original vectors can be used by the embedded system, such that the burn-in efficiency of the SOC is improved, and burn-in is more reasonable and effective.

### BRIEF DESCRIPTION OF THE DRAWINGS

FIGURE is a flow diagram of a format conversion and application method for SOC DFT burn-in vectors.

### DETAILED DESCRIPTION OF THE EMBODIMENTS

The technical solutions in some embodiments of the invention are described in detail below in conjunction with drawings of these embodiments.

### Embodiment 1

As shown in Figure which is a flow diagram of a format conversion and application method for SOC DFT burn-in vectors, the format of original vectors is converted, valid vector data are extracted for character substitution, and a stimulus data source that can be directly used by an embedded system is obtained quickly, such that the coverage of a logic gate circuit in the burn-in process of an SOC is increased.

The invention provides a format conversion and application method for SOC DFT burn-in vectors, wherein a vector generation tool, a format conversion tool and a test tool are used in DFT. The vector generation tool is an ATPG tool, the format conversion tool is a Synopsys TetraMAX conversion tool, and the test tool is a conventional test system board, such as a test system board designed for a general purpose embedded system. In addition, the tools specifically used in the method may be changed as long as actual demands can be satisfied.

The format conversion and application method for SOC DFT burn-in vectors includes the following steps:
S1, after DFT of an SOC is completed, multiple original vectors in an STIL format are generated by the ATPG tool, wherein each original vector has a corresponding signal set which defines signal pins and an input/output type adopted by the vector, each signal set includes PI and PO signal pins, the PI signal pin represents an input terminal, and the PO signal pin represents an output signal; a timeplate corresponding to each original vector is set, and correspondingly, all the signal sets adopt a unified waveform template; and after the setting is completed, primary simulation is performed on each original vector, and then, each original vector is preliminarily modulated according to the coverage of a logic gate circuit of the SOC in a primary simulation result to increase the coverage of the logic gate circuit and correspondingly improve the effectiveness of a subsequent burn-in test.

It should be noted that different original vectors may adopt the same signal set or different signal sets. Each signal value in the signal set indicates a signal status at a specific time. In a case where users desire to repeat a test or observe the same signal set, different original vectors may adopt the same signal set to verify the stability, consistency and other performance indicators. In a case where different original vectors adopt different signal sets, different functions, different paths or the status in different operating environments can be tested, the overall functions can be tested more systematically, and potential problems or faults can be found.

The original vectors adopted in this embodiment is in the STIL format and may also be in a WGL format. In vectors in the STIL format, signal data are described in parallel, while in vectors in the WGL format, signal data are described in series. Compared with the vectors in the WGL format, the vectors in the STIL format are more beneficial to data extraction and processing. In an actual test, the format of the vectors can be selected autonomously according to test requirements and environments.

Timeplate is a vector syntactic keyword in the standard test interface language (STIL) or the waveform generation language (WGL), and it defines a signal waveform and can accurately characterize the relation between time and operation or the relation between time and signal variation.

In this embodiment, the original vectors are in the STIL format, which may include a signal set definition, a stimulus data source, timeplate and other information corresponding to the original vectors. Because all these types of information are integrated together and cannot be easily used in the burn-in test, format conversion needs to be performed later to convert the vectors in the STIL format into vectors in a format easy to process.

In this embodiment, the signal set of the vector is a group of ordered vectors, indicates a test signal and is used for describing and testing behaviors of a system. In this embodiment, the signal set is used in the burn-in test to simulate a long-term operating condition to detect the stability and reliability of a system.

In this embodiment, the original vectors may include SCAN STUCK vectors, SCAN TRANSATION vectors, MBIST vectors, BSCAN vectors, etc. Different types of vectors often have different initial configurations and cannot run synchronously in one period. For any type of vectors, the number of the vectors will vary in chips of different sizes. In a case where one vector cannot realize desired coverage, multiple vectors will be used to obtain the desired coverage. There is no correlative dependence between different vectors, and the original vectors should include multiple types of vectors to increase the coverage of the logic gate circuit of the SOC.

In addition, in this embodiment, to ensure that the burn-in test can be carried out smoothly, power simulation may be performed on each original vector after the original vector is preliminarily modulated, and each original vector is iterated according to obtained power data, such that power is more stable in the whole burn-in test, and the test can be carried out more stably.

S2, each original vector preliminarily modulated in S1 is converted into a vector in a flat format by the Synopsys TetraMAX conversion tool. Each vector in the flat format obtained after format conversion includes: a signal set (signal list and direction, and other data), a waveform in each signal pin cycle, and a test pattern set (corresponding values of the PI signal pin and the PO signal pin in each cycle).

The flat format is a simple vector representation. In the flat format, all elements in a vector are stored in a continuous memory space, and each element occupy a fixed number of bytes. The flat format has the advantages of being simple and easy to implement. By converting the vectors in the STIL format into vectors in the flat format, the processing flow can be simplified, and the processing speed and efficiency can be improved.

S3, according to format features of each vector in the flat format in S2, corresponding vector data are recognized from each vector in the flat format, and character substitution is performed on each piece of vector data. The format features at least include vector syntactic keywords including signal, vector, pattern, loop and timeplate, and according to these vector syntactic keywords, data and characters corresponding to each vector syntactic keyword can be extracted from each vector in the flat format.

In this embodiment, the vector in the flat format also includes signal pin data. In an actual test, data are further extracted from the vector data extracted from the vector in the flat format according to an index or flag corresponding to an actually used signal pin list, and the finally extracted data are in one-to-one correspondence with actual signal pins.

To facilitate subsequent processing and use of data files, special characters in the extracted data need to be substituted to convert the extracted data into a status that can be recognized and expressed by the test tool (embedded system).

In this embodiment, in DFT of the SOC, multiple pin signals will be adopted as actually needed; in S3, when character replacement is performed, each pin signal needs to be converted into a specific cycle waveform, and the pin signals are in one-to-one correspondence with the specific cycle waveforms; and then, character substitution is performed on specific characters in each piece of vector data according to each specific cycle waveform.

In this embodiment, during character substitution, because the extracted data also include characters “X”, “-”, “L”, “Z” and “H”, in addition to “0” and “1”, each character in the extracted data is substituted with a byte by means of the format conversion tool. For example, “0” in the data is substituted with a byte “0”, and “L” in the data is substituted with a byte “0”. The number of characters in the extracted data is equal to the number of bytes obtained after character substitution to ensure that the number of data bits before character substitution is the same as the number of data bits after character substitution; and the characters before character substitution are in one-to-one corresponded with the bytes after character substitution, thus facilitating the test on the embedded system and increasing the running speed.

In some embodiments, to simplify original data, a vector X in DFT indicates a status unconcerned, Z indicates a high impedance state, L indicates a low logic, H indicates a high logic, and 1 and 0 also indicate a high logic and a low logic respectively. In the aspect of signal output/input, the substitution of X and Z in an actual signal with the logic 0 or 1 will not affect an actual effect of a vector, so the vector can run normally after the characters in the vector are all substituted with the logics 0 and 1 of the embedded system.

To satisfy the correspondence in the number of signal pins of the vector data and to adapt to a general purpose embedded system, data bits within a fixed length of the vector data obtained after character substitutions need to be aligned. For example, the total number of PI and PO signal pins of a vector A is N, one beat of data is transferred in each cycle as defined by timeplate, 2^{M}(M≥log₂(N)+1) bytes in each beat of data are aligned, and cycles exceeding signal channels are filled with bytes 0. The total vector size is limited to N Byte, N=2^{M}×L(L is the total number of cycles of each vector, for example, if the size of each vector is 32M Byte, L is 2^{25-M}), the number of effective signal cycles is P, and finally, cycles within (L-P) are filled with bytes 0 for alignment.

S4, data bits within a fixed length of the vector data subjected to character substitution in S3 are aligned, a corresponding data flag field is added to the end of each piece of vector data, and all the vector data subjected to character substitution are spliced according to each data flag field to form a complete stimulus data source. With the vector A mentioned above as an example, a 2^{M}-byte data flag field is added to the end of each vector, all the vectors are spliced into a complete stimulus data source, and the 2^{M}-byte data flag field should include an end identifier, category and effective cycles P of the current vector. Then, the flag fields are analyzed by the test tool to distinguish different vectors to carry out a burn-in test with different vectors, and test results are fed back into the test tool.

In this embodiment, before the burn-in test is carried out, data of the stimulus data source are checked by cyclic redundancy check (CRC) for error correction. CRC is a fast algorithm that generates a brief fixed-bit check code according to a network data packet, a computer file or other data, is mainly used for detecting or checking errors that may be generated after data are transmitted or saved, can realize error detection by division and remainders, and has the advantages of being clear in principle and easy to implement. Before the burn-in test is carried out, the reliability of data of the stimulus data source can be further ensured by CRC, and an error, once found, can be corrected timely.

In addition to CRC, the data of the stimulus data source may be checked with an error correction code (ECC), which can also improve the accuracy of the data of the stimulus data source and avoid the interference of erroneous data on a subsequent test.

S5, the stimulus data source in S4 is loaded by the test tool to carry out the burn-in test, different vectors in the stimulus data source are distinguished by means of the data flag fields to carry out the burn-in test respectively, and a test result is obtained and fed back into the test tool; and in the time period required by the test, the test tool continuously monitors the output state of the SOC, and if the status of the SOC is normal in the whole test period, the burn-in test is completed.

In this embodiment, when the burn-in test is carried out, different vectors may be used for testing at the same time to shorten the processing time and improve processing efficiency; or, different vectors may be used for testing in batches to reduce the processing pressure of the system; in addition, different priorities may be set for different vectors to allow part of vectors to be processed first, for example, five vectors A, B, C, D and E in the stimulus data source are distinguished, and the task corresponding to the vector A is urgent and needs to be completed first, so a highest priority is set for the vector A, and the priority of the other four vectors can be set freely.

In this embodiment, the stimulus data source can be applied to a burn-in system designed based on the structure of a general purpose embedded system; and when the stimulus data source is input to the SOC to be tested as test stimulus data, whether the output state of the SOC is normal after the SOC receives the stimulus data is monitored by the burn-in system to determine whether burn-in test results of the SOC are valid.

### Specific Application Example

When vectors are planned in DFT of a SOC, the number of PI and PO signal pins is restrained to ensure that it will not exceed a range allowed by a test system board. All signal sets of the vectors adopt a unified timeplate, original vectors in an STIL format are generated by a ATPG tool, all input/output signals of the SOC in each cycle are in the STIL format, and instructions adopted in design are as follows:
vector(“_multiclock_capture_WFT_”); (vector definition)
{end_pattern 1815}; (end of vector in 1815th cycle)
{load unload}; (load, unload operation)
vector(“_default_WFT_”):=[00zz0001000zzzz0110]; (default stimulus vector)
vector(“_default_WFT_”):=[00zz0001000zzzz0110]; (default stimulus vector)
scan(“_default_WFT_”); (default_WFT_ is the signal waveform template adopted by the vector, _default_WFT_ is a specific signal waveform defined, using timeplate as a keyword)
output[zxout0 : zxoutOU3633]; (first output signal) output[zxout1 : zxout1U3633]:(second output signal)
input[“GWX_OCC_CHAINin”:GWX_OCC-CHAINinL3633]. (input)

To increase the reversal rate and the coverage of a logic circuit of a SOC, vectors are preliminarily modulated according to post-simulation result of DFT to obtain preliminarily modulated original vectors. After the original vectors are obtained, the original vectors in the STIL format are converted into vectors in a flat format by means of a Synopsys TetraMAX conversion tool, such that the vectors are converted from serial signals into parallel signals; and data in the vectors are shifted and converted, and data in each vector are converted into data formed by 0, 1 and x. Each vector in the flat format obtained after format conversion includes: a signal set definition (signal list and signal direction), timeplate in each signal pin cycle, and a test pattern set (values of PI and PO signal pins corresponding to each cycle).

Then, data are extracted from the vectors in the flat format, and matching is performed on syntactic keywords “signal”, “vector”, “pattern”, “loop” and “timeplate” in the vectors, and corresponding data and characters are extracted; then, the extracted data are copied and developed according to the number of loops in “loop”. Then, because the vectors in the flat format cover all signal pin data, data are further extracted from the data extracted from the vectors in the flat format according to a signal pin list used by a test system board, and the finally extracted data are obtained and in one-to-one correspondence with actual signal pins.

Then, character substitution is performed to convert the finally extracted data into a status that can be recognized and expressed by computers. Because data in “vector” are in one-to-one correspondence with signals in “signal” and are full scale signals and burn-in signals used for the burn-test are subsets in “signal”, data need to be extracted from a corresponding position of “vector” according to a mapping relation between signal pins defined by burn-in and signal pins in the signal list; next, each pin signal is determined according to the timeplate and is converted into a corresponding specific cycle waveform, and character substitution is performed on special characters in each piece of vector data according to each specific cycle waveform. In addition to “0” and “1”, the character X in the extracted “vector” data is also substituted with 0, and the characters before character substitution are in one-to-one correspondence with bytes obtained after character substitution.

After character substitution is completed, data files obtained after character substitutions need to be aligned and spliced. According to the correspondence in the number of signal pins of the test vectors and the characteristics of a computer system, data bits within a fixed length of data files obtained after character substation are aligned. The total number of PI and PO signal pins of the original vector A is two, one beat of data is transmitted in each cycle as defined by timeplate, 2^{M} bytes in each beat are aligned as required by M≥log₂(2)+1, and cycles exceeding signal channels are filled with bytes 0. The total number of cycles of the vector is L, the number of effective signal cycles is P, the total size of the vector is limited to N Byte according to N=2^{M}×L, and finally, cycles within (L-P) are filled with bytes 0 for alignment.

A 2^{M}-byte data flag field is added to the end of each piece of extracted vector data, and all the vectors are spliced to form a complete stimulus data source. The 2^{M}-byte data flag field includes an end identifier, category and effective cycle information of the current vector, and data that can be recognized by the computer system are obtained, recognized and then stored. Data stored in a memory address are as follows:
“002ff2e0h:00 00 80 F4 FF DF 04 00 FC FF 8F F4 FF DF 04 00”;
“002ff2f0h:FC FF 8F F4 FF DF 04 00 00 00 80 F4 FF DF 04 00”.

The test system board analyzes the flag fields to distinguish different vectors to carry out a corresponding burn-in test.

According to the invention, a dedicated burn-in oven is not needed, and SOC DFT vectors are extracted and converted to obtain a vector file that can be used in a general purpose embedded system as signal stimuli to drive an SOC to run for burn-in, such that the cost is greatly reduced; in addition, format conversion and character substation are performed on original vectors to obtain vectors that can directly run on the embedded system, such that the coverage of a logic gate circuit of the SOC is increased, and the effectiveness of a burn-in test is improved.

The above embodiments are merely used for explaining the technical concept of the invention and are not intended to limit the protection scope of the invention. Any modifications made based on the technical concept of the invention should also fall within the protection scope of the invention.

What is claimed is:

1. A format conversion and application method for system on chip (SOC) design for test/testability (DFT) burn-in vectors, wherein tools used in a DFT comprise a vector generation tool, a format conversion tool and a test tool, and the format conversion and application method comprises the following steps:
S1, after the DFT of an SOC is completed, generating a plurality of original vectors in a standard test interface language (STIL) format by the vector generation tool, and setting a timeplate corresponding to each original vector; performing primary simulation on each original vector, and preliminarily modulating each original vector according to a primary simulation result;
S2, converting, by the format conversion tool, each original vector preliminarily modulated in S1 into a vector in a flat format;
S3, according to format features of each vector in the flat format in S2, extracting a corresponding piece of vector data from each vector in the flat format, and performing character substitution on each piece of vector data;
S4, aligning data bits within a fixed length of the vector data subjected to character substitution in S3, adding a corresponding data flag field at an end of each piece of vector data, and splicing all the vector data subjected to character substitution according to each data flag field to form a complete stimulus data source; and
S5, loading, by the test tool, the stimulus data source in S4 to complete a burn-in test.

2. The format conversion and application method according to claim 1, wherein the plurality of original vectors generated in S1 comprises a plurality of signal sets in correspondence, and the plurality of signal sets adopt a unified waveform template.

3. The format conversion and application method according to claim 1, wherein in S3, a method for extracting corresponding vector data from each vector in the flat format comprises: recognizing vector syntactic keywords in each vector in the flat format, and extracting the corresponding vector data from each vector in the flat format according to the vector syntactic keywords.

4. The format conversion and application method according to claim 1, wherein in S1, a plurality of pin signals are used in the DFT of the SOC; and when character substitution is performed in S3, each pin signal is converted into a corresponding specific cycle waveform, and character substitution is performed on special characters in each piece of vector data according to each specific cycle waveform.

5. The format conversion and application method according to claim 1, wherein in S3, a number of characters of each piece of vector data before character substitution is equal to a number of bytes of the piece of vector data after character substitution, and the characters before character substitution are in one-to-one correspondence with the bytes after character substitution.

6. The format conversion and application method according to claim 1, wherein in S4, each data flag field at least comprises an end identifier, a category and effective cycles of the corresponding vector data.

7. The format conversion and application method according to claim 1, wherein in S5, before the burn-in test is carried out, data of the stimulus data source are checked by cyclic redundancy check (CRC).

8. The format conversion and application method according to claim 1, wherein in S2, each vector in the flat format at least comprises a corresponding signal set definition, a corresponding timeplate and a corresponding pattern set.

9. The format conversion and application method according to claim 1, wherein in S5, the test tool is an embedded test system board.
